(19) United States
(12) Patent Application Publication
(10) Pub. No.: US 2015/0214574 A1
(43) Pub. Date: Jul. 30, 2015

(54) METHOD FOR PRODUCING SULFIDE SOLID ELECTROLYTE

(71) Applicant: TOYOTA JIDOSHA KABUSHIKI KAISHA, Toyota-shi (JP)

(72) Inventor: Takumi TANAKA, Suntou-gun (JP)

(21) Appl. No.: 14/599,006

(22) Filed: Jan. 16, 2015

(30) Foreign Application Priority Data
Jan. 24, 2014 (JP) 2014-011191

(51) Int. Cl. H01M 10/0562

(52) U.S. Cl. CPC H01M 10/0562; H01M 2300/008

(57) ABSTRACT

Provided is a method for producing a sulfide solid electrolyte capable of producing a sulfide solid electrolyte whose ion conductive property is improved, by using a raw material including LiBr. The method for producing a sulfide solid electrolyte includes a charging step of charging a raw material for producing a sulfide solid electrolyte mainly including a substance represented by a general formula (100-x) (0.75Li₂S. 0.25P₂S₅).xLiBr (0<x<100) in a container, after the charging step, an amorphizing step of producing an amorphous body in which the raw material is amorphizied, after the amorphizing step, a firing step of firing the amorphous body, wherein a temperature y[° C.] in a reaction field in the container in the amorphizing step is controlled such that x included in the above general formula and y satisfy y<0.5x+1.48×10².

### BACKGROUND OF INVENTION

1. Field of Invention

The present invention relates to a method for producing a sulfide solid electrolyte, and specifically relates to a method for producing a sulfide solid electrolyte using a raw material including LiBr.

2. Description of Related Art

A metal ion secondary battery having a solid electrolyte layer prepared with a flame-retardant solid electrolyte (for example, a lithium-ion secondary battery and the like. Hereinafter sometimes referred to as “all-solid-state battery”) has advantages that it can easily simplify a system to ensure safety and the like.

As a technique related to such an all-solid-state battery, for example Patent Document 1 discloses a technique of producing a Li₂S—P₂S₅ based crystallized glass (lithium-ion-conductive sulfide based crystallized glass) by means of a mechanical milling method.

### CITATION LIST

### Patent Literatures

Patent Document 1: Japanese Patent Application Laid-Open No. 2005-228570

### SUMMARY OF INVENTION

### Problems to be Solved by Invention

A Li₂S—P₂S₅—LiBr electrolyte in which LiBr is added to a Li₂S—P₂S₅ based electrolyte which is a sulfide solid electrolyte having ion conductivity can express a high ion conductive property. These sulfide solid electrolytes can be produced by means of a mechanical milling method as disclosed in Patent Document 1. However, in producing these sulfide solid electrolytes by means of the technique disclosed in Patent Document 1, if the temperature when the mechanically milling is underway is increased, there is a drawback that the obtained sulfide solid electrolyte tends to have a low ion conductive property.

Accordingly, an object of the present invention is to provide a method for producing a sulfide solid electrolyte capable of producing a sulfide solid electrolyte whose ion conductive property is increased, by using a raw material including LiBr.

### Means for Solving Problems

As a result of an intensive study, the inventor of the present invention has found out that: in producing a sulfide solid electrolyte mainly including a substance represented by the general formula (100-x) (0.75Li₂S.0.25P₂S₅) xLiBr (0<x<100) with a raw material including LiBr, if a temperature y [° C.] in a reaction field in a container for synthesizing a sulfide glass has a predetermined value or more, a specific crystal phase (Li₃PS₄ crystal phase. The same is applied hereinafter) appears, and the sulfide solid electrolyte having this specific crystal phase tends to have a low ion conductive property. Further, the inventor has found out that: by controlling the temperature y in the reaction field in the container for synthesizing the sulfide glass so that the above x and y satisfy a predetermined conditional expression, it becomes possible to prevent the appearance of the specific crystal phase, whereby it becomes possible to produce a sulfide solid electrolyte whose ion conductive property is increased. In addition, the inventor has found out that: by controlling the temperature y in the reaction field in the container for synthesizing the sulfide glass, it becomes possible to prevent the appearance of the above specific crystal phase and at the same time to increase productivity of the sulfide solid electrolyte whose ion conductive property is increased. The present invention has been made based on the above findings.

In order to solve the above problems, the present invention takes the following means.

Namely, the present invention is a method for producing a sulfide solid electrolyte, the method including: a charging step of charging a raw material for producing a sulfide solid electrolyte mainly including a substance represented by the general formula (100-x) (0.75Li₂S.0.25PS₅).xLiBr (0<x<100, the same is applied hereinafter) to a container; amorphizing step of making an amorphous body in which the above raw material is amorphized; and a firing step of firing the amorphous body after the amorphizing step, wherein a temperature y [° C.] in a reaction field in the container is controlled so that x included in the above general formula and y satisfy the following Formula (1).

y<0.5x+1.48×10² Formula (1)

Here, in the present invention, the expression “sulfide solid electrolyte mainly including a substance represented by the general formula (100-x) (0.75Li₂S.0.25P₂S₅) xLiBr” means that the ratio of the sulfide solid electrolyte represented by the general formula (100-x) (0.75Li₂S.0.25P₂S₅) xLiBr included in the sulfide solid electrolyte is at least 50 mol % or more. Also, the “raw material for producing the sulfide solid electrolyte mainly including a substance represented by the general formula (100-x) (0.75Li₂S.0.25P₂S₅).xLiBr” is not particularly limited as long as a Li₂S—P₂S₅—LiBr electrolyte can be produced with the raw material (hereinafter sometimes simply referred to as “electrolyte raw material”). Examples of such an electrolyte raw material include a combination of Li₂S, P₂S₅, and LiBr, a combination of other raw materials including Li, P, S, and Br and the like. Also, in the present invention, the “charging step” is not particularly limited as long as it is a step of charging at least the electrolyte raw material in the container, and it can also be a step of charging a liquid used in a wet mechanical milling method to the container for example, in addition to the electrolyte raw material. Also, in the present invention, the “amorphizing step” can be: a wet mechanical milling using a liquid such as hydrocarbon, which does not react with the raw material or the electrolyte to be produced; a dry mechanical milling which does not use the liquid; or a melt quenching method. In addition, a method other than the mechanical milling method, with which the raw material charged in the container is heated and stirred to be amorphized, can also be used. It should be noted that, in a case where the amorphizing step has a configuration in which the raw material is amorphized by means of a mechanical milling method, the expression “a temperature in a reaction field in the container is controlled so that x included in the above general formula and y satisfy the following Formula (1)” means that the temperature in the reaction field in the container is controlled so that the maximum temperature in the reaction field in the amorphizing step satisfies the above Formula (1). In contrast, in a case where the amorphizing step has a configuration in which the raw material is amorphized by means of a melt quenching method, the expression “a temperature in a reaction field in the container is controlled so that x included in the above general formula and y satisfy the following Formula (1)” means that the temperature in the reaction field in the container is controlled so that the reaching temperature (minimum temperature) in rapidly cooling the raw material after once the temperature is increased to satisfy y≧0.5x+1.48×10² in the amorphizing step satisfies the Formula (1). Also, in the present invention, the “firing step” is a step of firing the amorphous body obtained in the amorphizing step to produce a crystallized Li₂S—P₂S₅—LiBr electrolyte. The configuration of the firing step is not particularly limited as long as it is a step of producing the crystallized Li₂S—P₂S₅—LiBr electrolyte while avoiding the formation of the above specific crystal phase.

By having the amorphizing step of amorphizing the raw material while controlling the temperature y in the reaction field in the container in amorphizing the raw material so that y satisfies the above Formula (1), it becomes possible to produce the crystallized Li₂S—P₂S₅—LiBr electrolyte without having the specific crystal phase which causes the deterioration of the ion conductivity. By avoiding the appearance of the crystal which causes the deterioration of the ion conductivity, it becomes possible to increase the ion conductive property of the produced Li₂S—P₂S₅—LiBr electrolyte.

Also, in the present invention, x may be x≧5 (5 x<100)

Also, in the present invention, it is preferable to make the temperature in the reaction field in the container as 40° C. or more in the amorphizing step. This configuration makes it easy to increase the speed to amorphize the material and synthesize the sulfide glass, whereby it becomes easy to reduce the producing cost of the sulfide solid electrolyte.

Also, in the present invention, it is preferable to give a thermal energy into the container in the amorphizing step. This configuration makes it possible to control the synthetic rate of the sulfide glass, via the control of the thermal energy to give. As a result, it becomes easy to produce the sulfide solid electrolyte having a good ion conductive property while increasing the synthetic rate of the sulfide glass.

Here, the expression “give a thermal energy into the container” means not only a configuration of heating the container from outside of the container to give the thermal energy into the container, but also a configuration of generating the thermal energy in the container without using an external heat source, then inhibiting heat radiation, to thereby make the temperature in the reaction field in the container as a predetermined temperature or more (for example, a configuration of using a larger container than the container used for carrying out heating from outside, in a mechanical milling method) and the like for example.

Also, in the present invention, the amorphizing step can be a step of amorphizing the raw material by means of a wet mechanical milling method. This configuration also makes it possible to produce the sulfide solid electrolyte whose ion conductive property is increased, by using a raw material including LiBr.

### Effects of Invention

According to the present invention, it is possible to provide a method for producing a sulfide solid electrolyte capable of producing a sulfide solid electrolyte whose ion conductive property is increased by using a raw material including LiBr.

### BRIEF DESCRIPTION OF DRAWINGS

FIG. 1 is a flowchart to explain the method for producing a sulfide solid electrolyte of the present invention;

FIG. 2 is a graph showing results of X-ray diffraction measurement;

FIG. 3 is a graph showing results of X-ray diffraction measurement;

FIG. 4 is a graph showing results of X-ray diffraction measurement;

FIG. 5 is a graph to explain the experimental result.

### DETAILED DESCRIPTION OF INVENTION

Hereinafter the present invention will be described with reference to the drawings. It should be noted that the embodiments shown below are examples of the present invention, and the present invention is not limited to the embodiments.

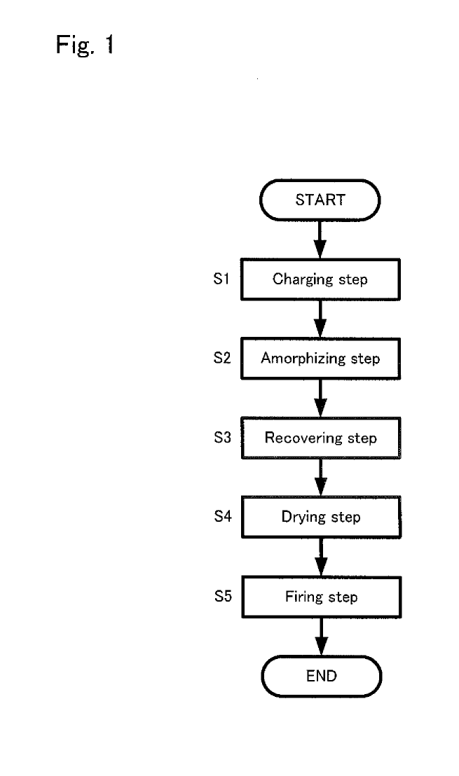

FIG. 1 is a flowchart to explain the method for producing a sulfide solid electrolyte of the present invention (hereinafter the method is sometimes simply referred to as “the present invention”). The present invention shown in FIG. 1 includes a charging step (S1), an amorphizing step (S2), a recovering step (S3), a drying step (S4), and a firing step (S₅).

The charging step (hereinafter sometimes referred to as “S1”) is a step of charging a raw material for producing a Li₂S—P₂S₅—LiBr electrolyte. For example, in a case where the amorphizing step which is described later is a step of synthesizing the Li₂S—P₂S₅—LiBr electrolyte by means of a wet mechanical milling method, S1 can be a step of charging the electrolyte raw material and a liquid such as hydrocarbon, which does not react with the electrolyte raw material or the Li₂S—P₂S₅—LiBr electrolyte to be synthesized in a container.

Here, examples of the electrolyte raw material which can be used in S1 include a combination of Li₂S, P₂S₅, and LiBr, a combination of other raw materials including Li, P, S, and Br and the like. Also, examples of the liquid which can be used in S1 include alkanes such as heptane, hexane, and octane, and aromatic hydrocarbons such as benzene, toluene, and xylene.

The amorphizing step (hereinafter sometimes referred to as “S2”) is a step of synthesizing an amorphous body (amorphous glass) in which the raw material charged in the container in S1 is amorphized. In a case where the liquid is charged in the container together with the electrolyte raw material in S1, S2 can be a step of amorphizing the raw material by means of a wet mechanical milling method to synthesize the sulfide glass. In contrast, in a case where the liquid is not charged in the container together with the electrolyte raw material in S1, S2 can be a step of amorphizing the raw material by means of a dry mechanical milling method to synthesize the sulfide glass. In addition, S2 can be a step of amorphizing the raw material by means of a melt quenching method to synthesize the sulfide glass. It should be noted that, in view of having a configuration in which the producing cost is easily reduced since the treatment can be carried out at normal temperature and the like, S2 is preferably a step of synthesizing the sulfide glass by means of a mechanical milling method (wet or dry). Further, in view of having a configuration in which a sulfide glass having a higher amorphous property can be obtained by preventing the raw material composition from adhering to a wall surface of the container and the like, S2 is preferably a step of synthesizing the sulfide glass by means of a wet mechanical milling method. The melt quenching method has limitations in its reaction atmosphere and reaction container. In contrast, the mechanical milling method has an advantage that the sulfide glass having an objective composition can be synthesized easily.

In order to prevent the formation of the specific crystal phase which is confirmed in the Li₂S—P₂S₅—LiBr electrolyte whose ion conductive property is deteriorated, in S2, the sulfide glass is synthesized while controlling the temperature y [° C.] in the reaction field in the container so that the LiBr content x [mol %](the content x [mol %] of LiBr included in the electrolyte raw material) wherein the Li₂S—P₂S₅—LiBr electrolyte is represented by the general formula (100-x) (0.75Li₂S.0.25P₂S₅).xLiBr, and y satisfy the following Formula (1).

y<0.5x+1.48×10² Formula (1)

As described above, by synthesizing the sulfide glass while controlling the temperature in the reaction field in the container so that x and y satisfy the above Formula (1), it becomes possible to prevent the formation of the specific crystal phase which is confirmed in the Li₂S—P₂S₅—LiBr electrolyte whose ion conductive property is deteriorated. As a result, it becomes possible to produce the sulfide solid electrolyte (Li₂S—P₂S₅—LiBr electrolyte. The same is applied hereinafter) whose ion conductive property is improved.

The inventor has found out that: for example, in a case where a predetermined planetary ball-milling machine is used, if the container is heated from outside, the temperature in the reaction field in the container in synthesizing the sulfide glass in S2 becomes same as the temperature of the outer surface of the container. Therefore, for example in a case where this planetary ball-milling machine is used, it is possible to indirectly control the temperature in the reaction field in the container by controlling the temperature of the outer surface of the container. In addition, in a case where the sulfide glass is synthesized by going through the process of rapid cooling as well, it is possible to indirectly controlling the temperature in the reaction field in the container by controlling the temperature of the outer surface of the container.

The recovering step (hereinafter sometimes referred to as “S3”) is a step of taking out from the container and recovering the sulfide glass synthesized in S2.

The drying step (hereinafter sometimes referred to as “S4”) is a step of drying the sulfide glass recovered in S3 to thereby volatilize the liquid charged in the container together with the electrolyte raw material. For example, in a case where S2 is a step of synthesizing the sulfide glass by means of a dry mechanical milling method, S4 is not needed.

The firing step (hereinafter sometimes referred to as “S5”) is a step of firing the sulfide glass obtained by going through S1 to S4 (for example, in a case where S2 is a step of synthesizing the sulfide glass by means of a dry mechanical milling method, the sulfide glass obtained by going through S1 to S3), to produce the crystallized Li₂S—P₂S₅—LiBr electrolyte. Since the formation of the specific crystal phase is prevented in S2, by crystallizing the sulfide glass in S₅, it is possible to produce the sulfide solid electrolyte whose ion conductive property is improved. It should be noted that the firing in S5 has conditions with which the specific crystal phase is not formed. The firing temperature in S5 is preferably 100° C. or more and 500° C. or less.

By going through the above S1 to S₅, the sulfide solid electrolyte can be produced. In the producing method of the present invention, the sulfide glass is synthesized while the temperature y in the reaction field in the container is controlled in synthesizing the sulfide glass so that y satisfies the above Formula (1). By synthesizing the sulfide glass while the temperature is controlled as above, it becomes possible to prevent the formation of the specific crystal phase which is confirmed in the Li₂S—P₂S₅—LiBr electrolyte whose ion conductive property is deteriorated. Therefore, according to the producing method of the present invention, it becomes possible to produce the sulfide solid electrolyte whose ion conductive property is improved.

In the above explanation, a configuration in which the temperature in the reaction field in the container is controlled when the sulfide glass is being synthesized in the amorphizing step so that x and y satisfy the above Formula (1) is exemplified. As described above, by controlling the temperature in the reaction field in the container when the sulfide glass is being synthesized in the amorphizing step so that x and y satisfy the above Formula (1), it becomes possible to produce the sulfide solid electrolyte whose ion conductive property is improved. Here, in order to improve the productivity of the sulfide solid electrolyte whose ion conductive property is improved, it is preferable to increase the temperature in the reaction field in the amorphizing step as high as possible within a range satisfying the above Formula (1). From this viewpoint, in the producing method of the present invention, it is preferable to make the temperature in the reaction field in the container as 40° C. or more in the amorphizing step, and to give a thermal energy into the container. From the same viewpoint, the temperature in the reaction field in the container is more preferably 60° C. or more, further preferably 80° C. or more, and still preferably 100° C. or more. In the present invention, it becomes possible to shorten the synthesis time of the sulfide glass by controlling the temperature y in the reaction field to be as high as possible within the range satisfying the above Formula (1). Therefore, it becomes possible to reduce the producing cost of the sulfide solid electrolyte.

Further, as described later, by controlling the temperature in the reaction field in the container when the sulfide glass is being synthesized in the amorphizing step, so that x and y satisfy not only the above Formula (1) but also the following Formula (2), it becomes easy to produce the sulfide solid electrolyte whose ion conductive property is improved. Therefore, in the present invention, it is preferable to control the temperature y in the reaction field in the container when the sulfide glass is being synthesized, so that y satisfies the following Formula (2).

y≦0.5x+1.43×10² Formula (2)

### EXAMPLES

Hereinafter, Examples are shown to further specifically describe the present invention.

### 1. Production of Sulfide Solid Electrolyte

### Example 1

As the electrolyte raw material, lithium sulfide (Li₂S, manufactured by Nippon Chemical Industrial CO., LTD., purity of 99.9%), phosphorus pentasulfide (P₂S₅, manufactured by Aldrich, purity of 99.9%), and lithium bromide (LiBr, manufacture by KOJUNDO CHEMICAL LABORATORY CO., LTD, purity of 99.9%) were used. These electrolyte raw materials were weighed such that the molar ratio thereof was Li₂S:P₂S₅:LiBr=71.25:23.75:5. The weighed electrolyte raw materials were put in a container (45 ml, made of ZrO₂) of a planetary ball-milling machine together with tridecane, and ZrO₂ balls having a diameter of 5 mm were further put in the container, then the container was completely sealed. In order to measure the temperature in the mechanical milling, a heat label (manufactured by MIKRON) was attached to the outer surface of the container.

This container was attached to the planetary ball-milling machine (manufactured by Ito Seisakusho Co., Ltd.) having a function to heat the container from outside, and mechanical milling was carried out at a set temperature of 140° C. for 20 hours, with a speed of 290 rotations per minute. Whereby, the sulfide glass (95(0.75Li₂S.0.25P₂S₅).5LiBr) of Example 1 was synthesized. At this time, the temperature of the outer surface (the reaching temperature of the heat label) of the container when the mechanical milling was underway was 140° C. From a preliminary experiment, it was confirmed that, with the planetary ball-milling machine, the temperature in the reaction field in the container was same as the temperature of the outer surface of the container. Therefore, the temperature y in the reaction field in Example 1 was 140° C.

After the mechanical milling was finished, 95(0.75Li₂S.0.25P₂S₅).5LiBr was recovered from the container and a vacuum drying was carried out at 80° C. to remove tridecane, whereby a sulfide solid electrolyte (95(0.75Li₂S.0.25P₂S₅).5LiBr) of Example 1 was obtained.

### Example 2

A sulfide solid electrolyte (85(0.75Li₂S 0.25P₂S₅).15LiBr) of Example 2 was synthesized with the same conditions as in Example 1, except that the electrolyte raw materials to be used were weighed such that the molar ratio thereof was Li₂S:P₂S₅:LiBr=63.75:21.25:15 and the temperature y in the reaction field was 150° C.

### Example 3

A sulfide solid electrolyte (75(0.75Li₂S 0.25P₂S₅).25LiBr) of Example 3 was synthesized with the same conditions as in Example 1, except that the electrolyte raw materials to be used were weighed such that the molar ratio thereof was Li₂S:P₂S₅:LiBr=56.25:18.75:25.

### Example 4

A sulfide solid electrolyte (75(0.75Li₂S 0.25P₂S₅).25LiBr) of Example 4 was synthesized with the same conditions as in Example 3, except that the temperature y in the reaction field was 150° C.

### Comparative Example 1

A sulfide solid electrolyte (95 (0.75Li₂S.0.25P₂S₅).5LiBr) of Comparative Example 1 was synthesized with the same conditions as in Example 1, except that the temperature y in the reaction field was 150° C.

### Comparative Example 2

A sulfide solid electrolyte (95(0.75Li₂S.0.25P₂S₅).5LiBr) of Comparative Example 2 was synthesized with the same conditions as in Example 1, except that the temperature y in the reaction field was 160° C.

### Comparative Example 3

A sulfide solid electrolyte (85(0.75Li₂S.0.25P₂S₅).15LiBr) of Comparative Example 3 was synthesized with the same conditions as in Example 2, except that the temperature y in the reaction field was 160° C.

### Comparative Example 4

A sulfide solid electrolyte (85(0.75Li₂S.0.25P₂S₅)15LiBr) of Comparative Example 4 was synthesized with the same conditions as in Example 2, except that the temperature y in the reaction field was 170° C.

### Comparative Example 5

The sulfide solid electrolyte (75(0.75Li₂S.0.25P₂S₅)25LiBr) of Comparative Example 5 was synthesized with the same conditions as in Example 3, except that the temperature y in the reaction field was 160° C.

### 2. Analysis

### [X-Ray Diffraction]

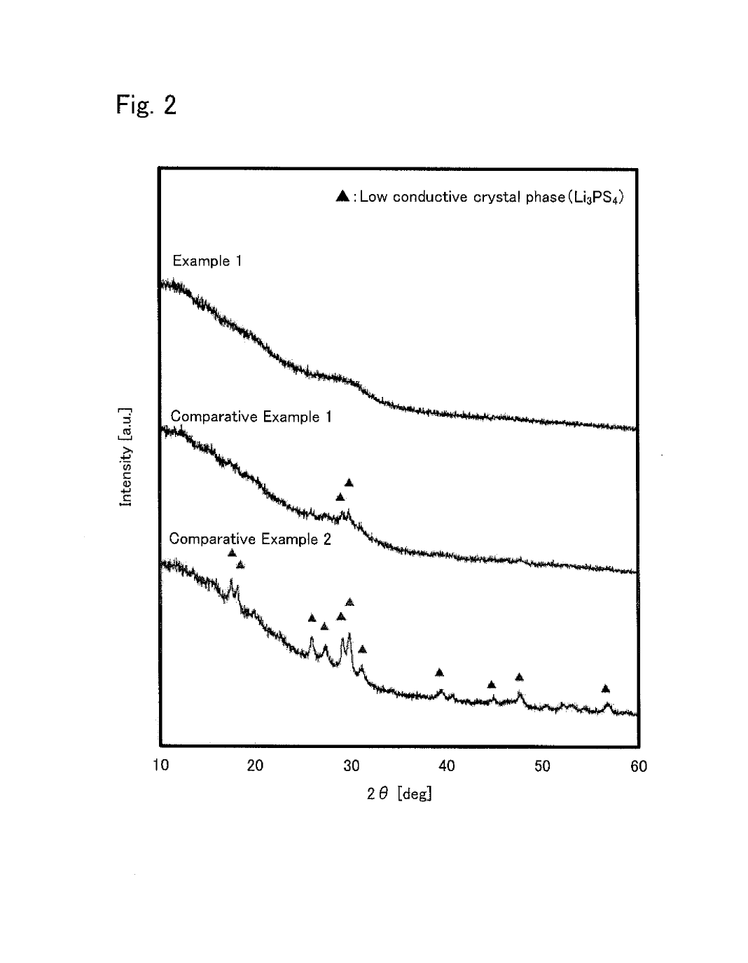

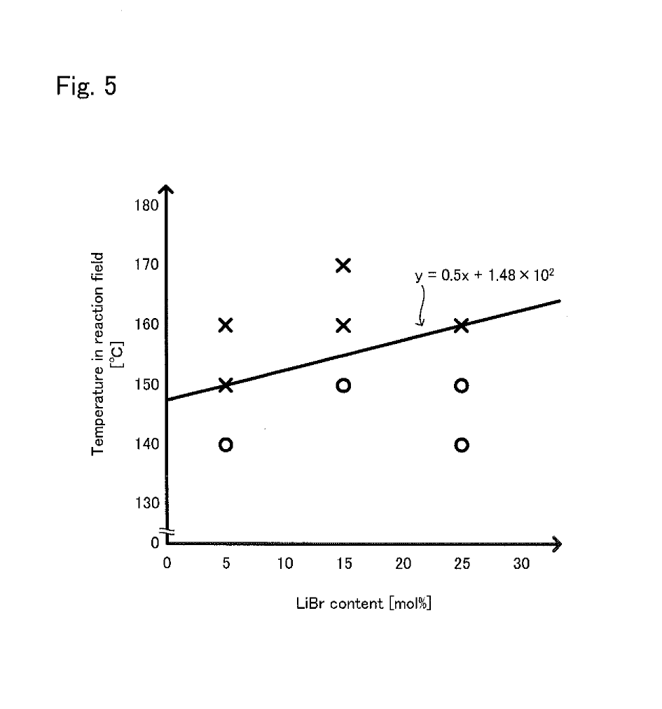

Regarding the sulfide solid electrolytes of Example 1 to Example 4, and the sulfide solid electrolytes of Comparative Example 1 to Comparative Example 5, the presence or absence of Li₃PS₄ crystal phase which was confirmed in the Li₂S—P₂S₅—LiBr electrolyte whose ion conductive property was deteriorated was examined. The X-ray diffraction patterns are shown in FIGS. 2 to 4, and the examination results regarding the presence or absence of Li₃PS₄ crystal phase are shown in FIG. 5.

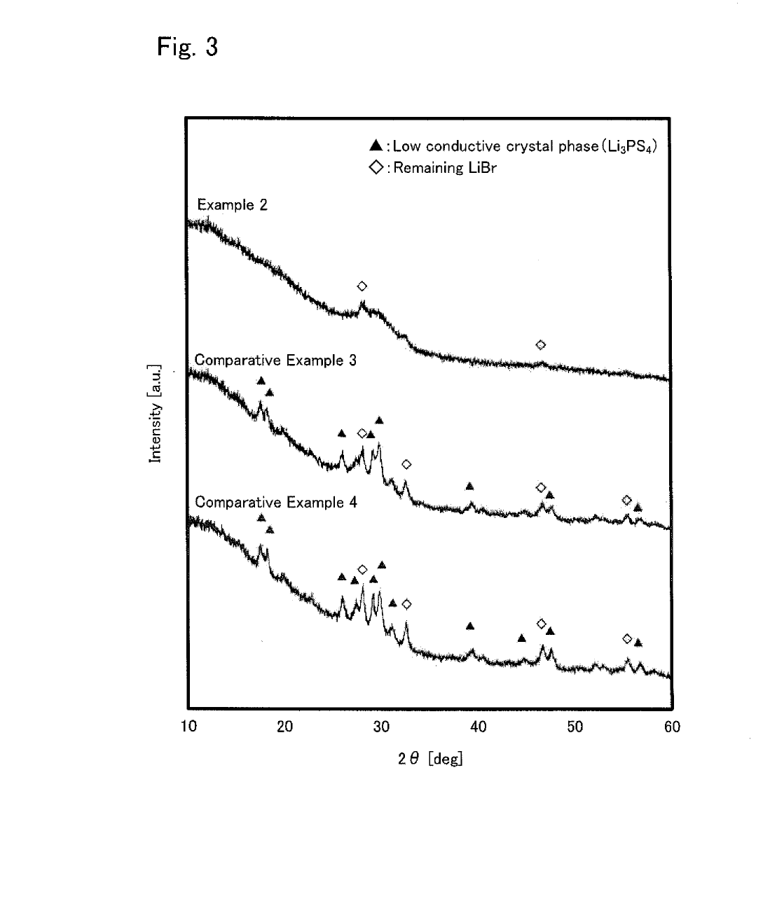

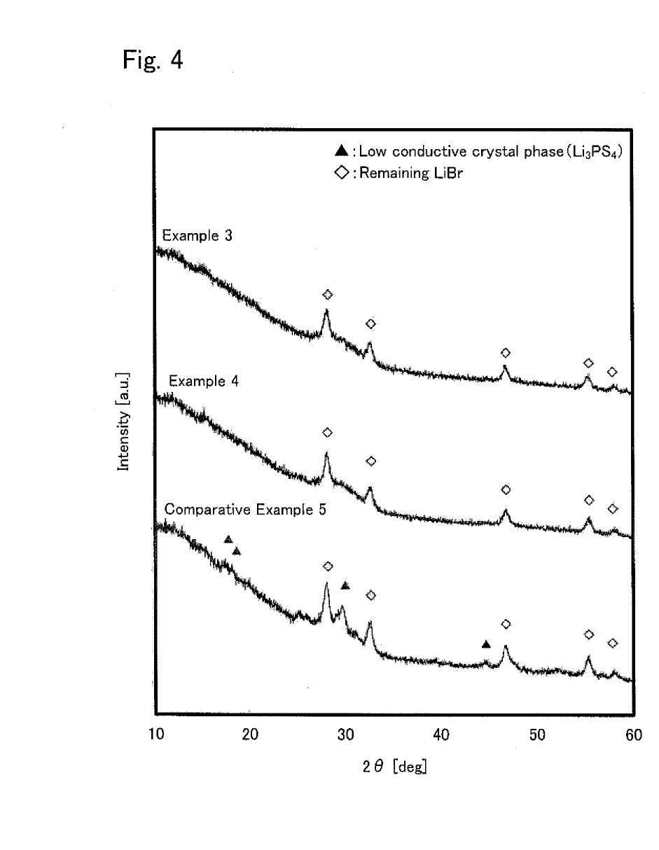

FIG. 2 is a graph showing the X-ray diffraction patterns of Example 1, Comparative Example 1, and Comparative Example 2 (95(0.75Li₂S 0.25P₂S₅).5LiBr). FIG. 3 is a graph showing the X-ray diffraction patterns of Example 2, Comparative Example 3, and Comparative Example 4 (85(0.75Li₂S.0.25P₂S₅).15LiBr). Also, FIG. 4 is a graph showing the X-ray diffraction patterns of Example 3, Example 4, and Comparative Example 5 (75(0.75Li₂S.0.25P₂S₅).25LiBr). In FIGS. 2 to 4, the diffraction intensity is taken along the vertical axis, and the diffraction angle 20 is taken along the horizontal axis. In FIGS. 2 to 4, “▴” shows that the peak is originated from Li₃PS₄ crystal phase. Also, in FIGS. 3 and 4, “K” shows that the peak is originated from LiBr.

Also, In FIG. 5, the temperature [° C.] in the reaction field is taken along the vertical axis, and LiBr content [mol %] in the electrolyte raw material is taken along the horizontal axis. In FIG. 5 and Table 1 which is described later, “o” shows that the Li₃PS₄ crystal phase was not confirmed, and “x” shows that the Li₃PS₄ crystal phase was confirmed. The straight line shown in FIG. 5 is y=0.5x+1.48×10² (x is the LiBr content [mol %] in the electrolyte raw material and y is the temperature [° C.] in the reaction field)

### [Identification of Ion Conductivity]

Each of the sulfide solid electrolyte of Example 2 and the sulfide solid electrolyte of Comparative Example 3 was fired by means of a hot plate at 210° C. for 2 hours, in a glove box having argon atmosphere whose dew point was controlled to be −80° C. or less. After that, the fired sulfide solid electrolyte was pelletized to calculate the Li ion conductivity (normal temperature) from the resistance value measured by means of AC impedance method. A solartron 1260 was used for the measurement, with the measurement conditions of 5 mV of applied voltage and 0.01 MHz to 1 MHz of measurement frequency band. The resistance value at 100 kHz was read, and correction was carried out to the value by means of the thickness, then the value was converted to the Li ion conductivity.

The Li ion conductivity is shown in FIG. 1 together with the producing conditions and the presence or absence of the low conductive crystal phase.

TABLE 1

| | | | temper- | | |
|---|---|---|---|---|---|
| | | | ature y | presence | |
| | | | in reac- | or absence | |
| | | molar ratio of | tion | of low con- | conduc- |
| | | raw material | field | ductive | tivity |
| | x | Li₂S:P₂S₅:LiBr | [° C.] | crystal phase | [S/cm] |
| Example 1 | 5 | 71.25:23.75:5 | 140 | ∘ | |
| Example 2 | 15 | 63.75:21.25:15 | 150 | ∘ | 2.59 × 10⁻³ |
| Example 3 | 25 | 56.25:18.75:25 | 140 | ∘ | |
| Example 4 | 25 | 56.25:18.75:25 | 150 | ∘ | |
| Comparative | 5 | 71.25:23.75:5 | 150 | x | |
| Example 1 | | | | | |
| Comparative | 5 | 71.25:23.75:5 | 160 | x | |
| Example 2 | | | | | |
| Comparative | 15 | 63.75:21.25:15 | 160 | x | 4.44 × 10⁴ |
| Example 3 | | | | | |
| Comparative | 15 | 63.75:21.25:15 | 170 | x | |
| Example 4 | | | | | |
| Comparative | 25 | 56.25:18.75:25 | 160 | x | |
| Example 5 | | | | | |

### 3. Result

The results are shown in FIG. 5. The straight line connecting the result of Comparative Example 1 and the result of Comparative Example 5 is y=0.5x+1.48×10². As shown in FIGS. 2 to 4, the Li₃PS₄ crystal phase was confirmed from the sulfide solid electrolytes of Comparative Example 1 to Comparative Example 5. In Comparative Example 1 to Comparative Example 5, x in (100-x) (0.75Li₂S.0.25P₂S₅).xLiBr and the temperature y in the reaction field satisfied the relationship y 0.5x+1.48×10². In contrast, as shown in FIGS. 2 to 4, the sulfide solid electrolytes of Example 1 to Example 4 were amorphous and the Li₃PS₄ crystal phase was not confirmed from these electrolytes. In Example 1 to Example 4, y<0.5x+1.48×10² was satisfied. It should be noted that since the straight line having a slope of 0.5 passing the result of Example 2 is y=0.5x+1.43×10², Example 1 to Example 4 satisfied y 0.5x+1.43×10².

Also, the Li ion conductivity of the fired sulfide solid electrolyte of Example 2 was 2.59×10⁻³ S/cm, whereas the Li ion conductivity of the fired sulfide solid electrolyte of Comparative Example 3 was 4.44×10⁻⁴ S/cm. That is, the Li ion conductivity of the sulfide solid electrolyte in which the Li₃PS₄ crystal phase was not confirmed (the fired sulfide solid electrolyte of Example 2) was higher than the Li ion conductivity of the sulfide solid electrolyte in which the Li₃PS₄ crystal phase was confirmed (the fired sulfide solid electrolyte of Comparative Example 3).

From the above, it was confirmed that it is possible to produce the Li₂S—P₂S₅—LiBr electrolyte whose ion conductive property is increased, by producing the sulfide solid electrolyte with a process of synthesizing a sulfide glass while controlling the temperature y in the reaction field, such that y satisfies y<0.5x+1.48×10². Also, it was found out that it becomes easy to produce the Li₂S—P₂S₅—LiBr electrolyte whose ion conductive property is increased, by producing the sulfide solid electrolyte with the process of synthesizing the sulfide glass while controlling the temperature y in the reaction field, such that y satisfies y≦0.5x+1.43×10².

As described above, in Example 1 to Example 4, by controlling the temperature y in the reaction field when the sulfide glass is synthesized by means of a wet mechanical milling method, it is possible to produce the Li₂S—P₂S₅—LiBr electrolyte whose ion conductive property is increased. Here, since a mechanical milling method is a method of synthesizing an objective substance by making solid raw materials react to each other, it can be considered that the technical idea of the present invention can be applied when solid raw materials are made to react to each other to synthesize the Li₂S—P₂S₅—LiBr electrolyte. Therefore, even in a case where a method other than the mechanical milling method is used when the Li₂S—P₂S₅—LiBr electrolyte is produced, if the method makes solid raw materials react to each other to synthesize the Li₂S—P₂S₅—LiBr electrolyte, it can be considered that it is possible to produce the Li₂S—P₂S₅—LiBr electrolyte whose ion conductive property is improved, by controlling the temperature in the reaction field when the synthesis is carried out.

1. A method for producing a sulfide solid electrolyte, the method comprising:
a charging step of charging a raw material in a container for producing a sulfide solid electrolyte mainly including a substance represented by a general formula (100-x) (0.75Li₂S.0.25P₂S₅).xLiBr (0<x<100);
after the charging step, an amorphizing step of making an amorphous body in which the raw material is amolphized; and
after the amorphizing step, a firing step of firing the amorphous body,
wherein
the temperature y [° C.] in a reaction field in the container in the amorphizing step is controlled such that x included in the general formula and y satisfy following Formula (1).
y<0.5x+1.48×10² Formula (1)

2. The method for producing the sulfide solid electrolyte according to claim 1, wherein x≧5.

3. The method for producing the sulfide solid electrolyte according to claim 1, wherein the temperature in the reaction field in the container is made to be 40° C. or more in the amorphizing step.

4. The method for producing the sulfide solid electrolyte according to claim 2, wherein the temperature in the reaction field in the container is made to be 40° C. or more in the amorphizing step.

5. The method for producing the sulfide solid electrolyte according to claim 1, wherein a thermal energy is given into the container in the amorphizing step.

6. The method for producing the sulfide solid electrolyte according to claim 2, wherein a thermal energy is given into the container in the amorphizing step.

7. The method for producing the sulfide solid electrolyte according to claim 3, wherein a thermal energy is given into the container in the amorphizing step.

8. The method for producing the sulfide solid electrolyte according to claim 4, wherein a thermal energy is given into the container in the amorphizing step.

9. The method for producing the sulfide solid electrolyte according to claim 1, wherein the amorphizing step is a step of amorphizing the raw material by means of a wet mechanical milling method.

10. The method for producing the sulfide solid electrolyte according to claim 2, wherein the amorphizing step is a step of amorphizing the raw material by means of a wet mechanical milling method.

11. The method for producing the sulfide solid electrolyte according to claim 3, wherein the amorphizing step is a step of amorphizing the raw material by means of a wet mechanical milling method.

12. The method for producing the sulfide solid electrolyte according to claim 4, wherein the amorphizing step is a step of amorphizing the raw material by means of a wet mechanical milling method.

13. The method for producing the sulfide solid electrolyte according to claim 5, wherein the amorphizing step is a step of amorphizing the raw material by means of a wet mechanical milling method.

14. The method for producing the sulfide solid electrolyte according to claim 6, wherein the amorphizing step is a step of amorphizing the raw material by means of a wet mechanical milling method.

15. The method for producing the sulfide solid electrolyte according to claim 7, wherein the amorphizing step is a step of amorphizing the raw material by means of a wet mechanical milling method.

16. The method for producing the sulfide solid electrolyte according to claim 8, wherein the amorphizing step is a step of amorphizing the raw material by means of a wet mechanical milling method.
